(19) United States
(12) Patent Application Publication
(10) Pub. No.: US 2010/0288073 A1
(43) Pub. Date: Nov. 18, 2010

(54) STEERING WHEEL FOR AUTOMOBILE AND METHOD OF FABRICATING THE SAME

(76) Inventors: Gi Ug SHIN, Ulsan (KR); Mun Seok Choi, Ulsan (KR); Young Jong Sung, Busan (KR); Dong Hae Suh, Gyeongsangbuk-do (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/609,033

(22) Filed: Oct. 30, 2009

(30) Foreign Application Priority Data
May 14, 2009 (KR) 10-2009-0042249

(51) Int. Cl. B62D 1/04; B29C 45/14

(52) U.S. Cl. 74/552; 264/132

(57) ABSTRACT

The present disclosure relates to a steering wheel for automobiles and a method of fabricating the same. The steering wheel is formed in multiple layers having a thickness difference of 2˜3 mm by multi-stage injection molding and has a pattern or picture between the layers to provide a luxurious and pleasant appearance. In the method, after being preheated in a dryer to remove moisture, a metal frame is subjected to primary to tertiary injection molding in a mold to form the multiple layers. Here, drying is performed to remove moisture from the surface of injection-molded parts to prevent deterioration in adherence and quality during the process. Here, the pattern or figure is inserted between the layers by pad printing or a combination of pad printing and vacuum deposition. The multi-stage injection molding allows various colors, patterns, and figures to be printed on injection-molded parts excluding the uppermost layer.

### CROSS-REFERENCE TO RELATED APPLICATION

This application claims the benefit under 35 U.S.C. §119 of Korean Patent Application No. 10-2009-0042249, filed May 14, 2009, which is hereby incorporated by reference in its entirety.

### BACKGROUND OF THE INVENTION

1. Field of the Invention

The present invention relates to a steering wheel for automobiles and a method of fabricating the same and, more particularly, to a steering wheel for automobiles and a method of fabricating the same, which can replace a conventional wood-grain hydraulic transfer process and includes forming a steering wheel in multiple layers having a thickness difference of 2˜3 mm by multi-stage injection molding and inserting a predetermined pattern or picture between the injection-molded layers to provide a luxurious and pleasant appearance.

2. Description of the Related Art

In general, a steering system is provided to motor vehicles to control a traveling direction of the vehicle, and includes a handling mechanism, a gear arrangement, and a link mechanism.

The handling mechanism serves to transfer operation of a driver to the gear arrangement and the link mechanism. The handling mechanism includes a steering wheel, a steering shaft, a column, and the like.

In the steering system, when the steering wheel is circumferentially rotated to control the traveling direction of the vehicle, the circumferential movement of the steering wheel is transferred to a steering gear, which in turn changes the circumferential movement into a linear movement to move wheels of the vehicle, thereby achieving the steering operation.

Since the steering wheel is a part of the steering system that is always gripped by a driver for steering operation, it is generally fabricated so as to prevent the driver's hands from slipping thereon during manipulation and to have a pleasant appearance. Recently, the steering wheel is fabricated to have cushion properties so as to prevent a driver from being subjected to strong impact upon collision.

A state-of-the-art steering wheel is generally fabricated by insert-molding a rim of a metal frame, which will be mounted on the steering shaft, using rigid polyurethane (PU) foam.

In this case, the rigid polyurethane foam provides some merits in terms of cushioning properties and non-slip to the steering wheel, but also provides a monotonous appearance and unpleasant tactile sensation. Therefore, a separate handle cover is generally used to cover an outer surface of the steering wheel.

However, although the handle cover slightly relieves the monotonous appearance and unpleasant tactile sensation of the current steering wheel, it entails an increase in thickness of the steering wheel, so that a driver cannot stably grip the steering wheel, thereby obstructing stable manipulation of the steering wheel.

In fabrication of a steering wheel for luxury cars, a leather handle is mounted on a rim of the steering wheel by integrally covering a leather cover on the rim, which is formed of the polyurethane foam and thinner than that of the general steering wheel. The leather handle compensates for the aforementioned problems, but still provides problems of slipping and unpleasant appearance caused by accumulation of dirt from the hands of a driver after extended use.

Further, some luxury cars are provided with a steering wheel, which is fabricated by integrally mounting a leather cover on a part of the rim formed of the polyurethane foam and forming a wood-grain film coating on the rest of the rim to provide a pattern and texture of wood, thereby providing a further pleasant and luxurious appearance while ensuring pleasant tactile sensation.

Typically, in fabrication of the steering wheel having the wood-grain film coating partially incorporated therein, only a part of the metal frame is formed of soft polyurethane foam and the rest is formed by injection molding of a resin, such as acrylonitrile butadiene styrene (ABS) or polypropylene (PP). Then, a wood-grain transfer film is coated on an outer surface of the injection-molded part to become coplanar therewith.

For such a wood-grain steering wheel, coating of the wood-grain transfer film is generally performed by hydraulic transfer. In this case, a number of processes are performed on the surface of the injection-molded layer composed of the ABS or PP resin prior to the hydraulic transfer.

That is, the ABS resin contains a reinforcing material such as glass fibers in an amount of 10˜20% for injection molding, so that the injection-molded surface is not smooth and includes fine pores and foreign matter. As a result, the injection-molded surface of the ABS resin is too uneven to transfer the wood-grain film thereto.

Accordingly, surface grinding is inevitably performed prior to hydraulic transfer to flatten the uneven surface of the foam layer and to remove the pores from the surface.

However, even when the surface grinding is performed before the hydraulic transfer, the wood-grain film is likely to be delaminated from the surface due to poor adhesion of the film. As a result, some of the film is stripped off from the steering wheels of new cars sold to consumers, thereby causing consumer dissatisfaction.

To solve such problems, Korean Patent No. 0887532 (Registration Date: Mar. 2, 2009) issued to the applicant of this invention suggests a new steering wheel and a method of fabricating the same. The invention of Korean Patent No. 0887532 is developed by improving the conventional hydraulic transfer process of coating a wood-grain pattern on the steering wheel. In this method, a part of the steering wheel is formed of a transparent or semi-transparent material by two-stage injection molding to reduce defect frequency while improving productivity and ensuring detection of defects before completion of fabrication. Further, the steering wheel includes a first upper coating and a second lower coating, which have first and second patterns on surfaces thereof, respectively, such that the first and second patterns can be observed through the first and second coatings, thereby enhancing a pleasant appearance of the steering wheel.

Referring to FIG. 1, a steering wheel 100 disclosed in Korean Patent No. 0887532 includes a rim 101 formed of a resin and divided into upper and lower portions 102, 103 by injection molding, a plurality of spokes 111 disposed inside the rim 101 and connected to the rim 101, and a hub core 118 disposed at the center of the rim 101 and including a core 112, to which an air-bag module (not shown) and a steering shaft (not shown) will be assembled.

The rim 101 includes a circular metal frame 106, which is covered by a resin and divided into a first zone corresponding to the upper and lower portions 102, 103 and a second zone corresponding to opposite lateral portions 107 between the upper and lower portions 102, 103.

In other words, the first zone corresponds to the upper and lower portions 102, 103 of a resin injection-molded part and has a predetermined pattern thereon. The second zone corresponds to a grip part to which a leather material is sewn, and is divided into the opposite lateral portions 107 of the resin injection-molded part.

Here, the upper portion 102 of the rim 101 includes a first upper coating 104, which is formed by covering the metal frame 106 by primary injection molding, and a second upper coating 105, which is formed by coating the first upper coating 104 by secondary injection molding. Similarly, the lower portion 103 of the rim 101 includes a first lower coating 108, which is formed by coating the metal frame 106 by the primary injection molding, and a second lower coating 105, which is formed by coating the first lower coating 108 by the secondary injection molding.

In the upper portion 102 of the rim 101, the first upper coating 104 is integrated with the second upper coating 105 by injection molding the resin on the metal frame 106. Similarly, in the lower portion 103 of the rim 101, the first lower coating 108 is integrated with the second lower coating 109 by injection molding the resin on the metal frame 106.

Further, the lateral portions 107 corresponding to the second zone of the metal frame 106 are provided with third coatings by tertiary injection molding, respectively.

The method of fabricating a steering wheel disclosed in Korean Patent No. 0887532 includes: inserting a steering wheel including a metal frame composed of first and second zones into a first mold, followed by heating the steering wheel to 60˜80° C. therein; injecting polycarbonate (PC) resin into the first mold to form a first coating covering the metal frame in the first zone; forming a pattern on the first coating in the first mold; cooling the first mold to cure the resin; inserting the steering wheel into a second mold and heating the steering wheel to 60˜80° C. therein; injecting transparent polycarbonate (PC) resin into the second mold to form a second coating on the first coating to have the same thickness as that of the first coating; cooling the second mold to cure the resin; inserting the steering wheel having the first and second coatings into a third mold; injecting polyurethane resin into the third mold to form a third coating on the metal frame in the second zone to have the same thickness as that of the first and second coatings in the first zone.

However, the method disclosed in Korean Patent No. 0887532 has some problems.

As mentioned above, the method includes inserting the steering wheel including the metal frame composed of the first and second zones into the first mold, followed by heating the steering wheel to 60˜80° C., and inserting the steering wheel into the second mold and heating the steering wheel to 60˜80° C. However, there is no practical process of inserting the steering wheel into the first or second mold and heating the steering wheel therein, and it is technically difficult to realize such a process in practice.

### BRIEF SUMMARY

The present invention is directed to solving the above and other problems of the related art, and an aspect of the invention is to provide a steering wheel for automobiles and a method of fabricating the same, which can replace a conventional wood-grain hydraulic transfer process and includes forming a steering wheel in multiple layers having a thickness difference of 2˜3 mm by multi-stage injection molding and inserting a predetermined pattern or picture between the injection-molded layers to provide a luxurious and pleasant appearance to the steering wheel.

Particularly, the inventor found based on repeated investigation that, when the outermost layer was maintained in an injection-molded thickness of 2˜3 mm with the pattern disposed under the outermost layer, the pattern appeared more pleasant and luxurious and provided a voluminous appearance. Therefore, another aspect of the invention is to protect mold manufacturing and injection molding technologies that can realize the result of the investigation.

A further aspect of the invention is to provide a steering wheel for automobiles and a method of fabricating the same that can prevent generation of waste water during fabrication of the steering wheel by application of pad printing or a combination of pad printing and vacuum deposition as a method of inserting the pattern into the steering wheel.

It should be understood that the invention provides the method of inserting the pattern into the steering wheel, thereby fundamentally solving the problem of the conventional film transfer process, which causes defects, such as film delamination, during interior operation and even after delivery of final products to consumers.

Further, since the conventional film transfer process is difficult and complicated, it is necessary to employ a robot or time-consuming pre-process. Thus, yet another aspect of the invention is to provide a steering wheel for automobiles and a method of fabricating the same that can permit production of the steering wheel only with a small number of operators.

In accordance with an aspect, the present invention provides a method of fabricating a steering wheel by injecting a resin material onto a circular metal frame, including: preheating the metal frame in a dryer at 80˜100° C. for 1 hour; forming a primary injection-molded part by inserting the metal frame into a primary injection mold, injecting an opaque resin into the primary injection mold to form the primary injection-molded part on the metal frame, and drying the metal frame having the primary injection-molded part at 80˜100° C. in the dryer; inserting a primary pattern part by performing pad printing on an upper side with reference to a border line of the primary injection-molded part to form an upper pattern, drying the metal frame having the upper pattern at 80˜100° C. in the dryer for 3 hours or more, performing pad printing on a lower side with reference to the border line of the primary injection-molded part to form a lower pattern, and drying the metal frame having the lower pattern at 80˜100° C. in the dryer for 3 hours or more; forming a secondary injection-molded part by inserting the metal frame having the primary pattern part into a secondary injection mold, injecting a transparent resin into the secondary injection mold to have a thickness 2˜3 mm greater than the primary injection-molded part, and drying the metal frame having the secondary injection-molded part at 80˜100° C. in the dryer; inserting a secondary pattern part by performing pad printing on an upper side with reference to a border line of the secondary injection-molded part to form an upper pattern, drying the metal frame having the upper pattern at 80˜100° C. in the dryer for 3 hours or more, performing pad printing on a lower side with reference to the border line of the secondary injection-molded part to form a lower pattern, and drying the metal frame having the lower pattern at 80˜100° C. in the dryer for 3 hours or more; forming a tertiary injection-molded part as an outermost layer by inserting the metal frame having the secondary pattern part into a tertiary injection mold and injecting a transparent resin into the tertiary injection mold to form the tertiary injection-molded part having a thickness 2˜3 mm greater than the secondary injection-molded part; and withdrawing the metal frame having the tertiary injection-molded part from the tertiary injection mold, and foaming polyurethane on an outer peripheral surface of the tertiary injection-molded part excluding the pattern parts to have a thickness, from which a thickness of leather constituting a rim of the steering wheel is subtracted, to provide a desired thickness of the rim.

In accordance with another aspect, the present invention provides a method of fabricating a steering wheel by injecting a resin material onto a circular metal frame, including: preheating the metal frame in a dryer at 80˜100° C. for 1 hour; forming a primary injection-molded part by inserting the metal frame into a primary injection mold, injecting an opaque resin into the primary injection mold to form the primary injection-molded part on the metal frame, and drying the metal frame having the primary injection-molded part at 80˜100° C. in the dryer; forming a vacuum deposition part by performing vacuum deposition on an outer peripheral surface of the primary injection-molded part to provide a metallic appearance and drying the metal frame having the vacuum deposition part at 80˜100° C. in the dryer; forming a secondary injection-molded part by inserting the metal frame having the vacuum deposition part into a secondary injection mold, injecting a transparent resin into the secondary injection mold to have a thickness 2˜3 mm greater than the primary injection-molded part, and drying the metal frame having the secondary injection-molded part at 80˜100° C. in the dryer; inserting a pattern part by performing pad printing on an upper side with reference to a border line of the secondary injection-molded part to form an upper pattern, drying the metal frame having the upper pattern at 80˜100° C. in the dryer for 3 hours or more, performing pad printing on a lower side with reference to the border line of the secondary injection-molded part to form a lower pattern, and drying the metal frame having the lower pattern at 80˜100° C. in the dryer for 3 hours or more; forming a tertiary injection-molded part as an outermost layer by inserting the metal frame having the pattern part into a tertiary injection mold and injecting a transparent resin into the tertiary injection mold to have a thickness 2˜3 mm greater than the secondary injection-molded part; and withdrawing the metal frame having the tertiary injection-molded part from the tertiary injection mold, and foaming polyurethane on an outer peripheral surface of the tertiary injection-molded part excluding the pattern part to have a thickness, from which a thickness of leather constituting a rim of the steering wheel is subtracted, to provide a desired thickness of the rim.

The opaque resin may be one of polycarbonate and polyethylene terephthalate.

The transparent resin forming the secondary and tertiary injection-molded parts may be one of polycarbonate and polyethylene terephthalate.

In accordance with a further aspect, the present invention provides a steering wheel fabricated by one of the methods described above.

### BRIEF DESCRIPTION OF THE DRAWINGS

The above and other aspects, features and advantages of the present invention will become apparent from the following detailed description of exemplary embodiments given in conjunction with the accompanying drawings, in which:

FIG. 1 is a perspective view of a conventional steering wheel with a pattern inserted therein;

FIG. 2 is a perspective view of a steering wheel having a pattern inserted therein by multi-stage injection molding according to one embodiment of the present invention;

FIG. 3 is a cross-sectional view of a steering wheel, according to one embodiment of the present invention, which has a pattern inserted into the steering wheel by pad printing during three-stage injection molding;

FIG. 4 is a cross-sectional view of a steering wheel, according to another embodiment of the present invention, which has a pattern inserted into the steering wheel by a combination of vacuum deposition and pad printing during three-stage injection molding;

FIG. 5 is a plan view of an upper mold for fabricating the steering wheel according to the embodiment of the present invention;

FIG. 6 is a plan view of a lower mold for fabricating the steering wheel according to the embodiment of the present invention;

FIG. 7 is a side-sectional view of the assembled upper and lower molds for fabricating the steering wheel according to the embodiment of the present invention; and

FIG. 8 shows variation in thickness of respective injection-molded parts according to the shape of a metal frame of a steering wheel formed by three-stage injection molding according to one embodiment of the present invention.

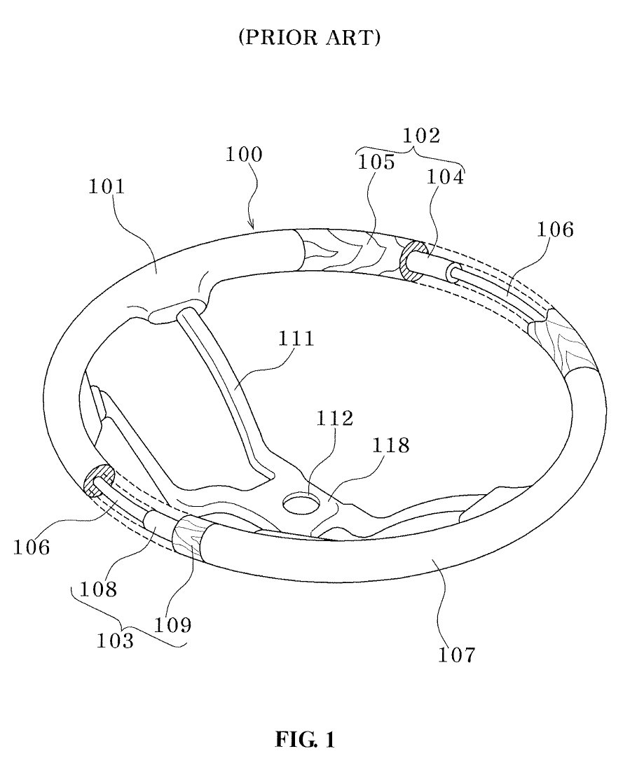

### DETAILED DESCRIPTION

Hereinafter, embodiments of the invention will be described in detail with reference to the accompanying drawings.

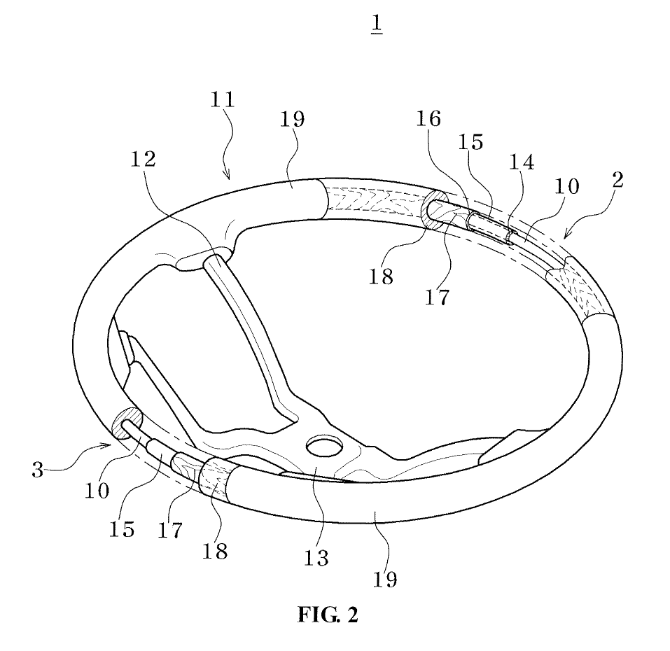

Referring to FIG. 2, as in the conventional steering wheel described above, a steering wheel 1 according to one embodiment of the invention also includes a rim 11 formed of a resin and divided into upper and lower portions 2, 3 by injection molding, a plurality of spokes 12 disposed inside the rim 11 and connected to the rim 11, and a hub core 13 disposed at the center of the rim 11 such that an air-bag module (not shown) and a steering shaft (not shown) can be assembled thereto.

According to the embodiment, the steering wheel is formed (in a multiple layers including at least two layers) by multi-stage injection molding. Specifically, the steering wheel according to this embodiment is formed in multiple layers having a thickness difference of 2˜3 mm by the multi-stage injection molding and includes a predetermined pattern or picture inserted between the injection-molded layers to provide a luxurious and pleasant appearance to the steering wheel.

In other words, the multi-stage injection molding method according to the invention permits printing of color, pattern, and the like on an inner coating excluding the uppermost coating of the steering wheel. Conventionally, the steering wheel is formed to have two injection-molded parts, that is, upper and lower injection-molded parts, and a single pattern is provided only to the lower injection-molded part. In contrast, according to the embodiment of the invention, the steering wheel is formed to have two or more injection-molded parts and two or more patterns are provided to the injection molded parts excluding the uppermost injection-molded part.

Here, it should be understood that new mold manufacturing and injection-molding technologies are demanded to prepare a mold satisfying the following requirements in order to form the rim 11 in multiple layers by injection molding.

First, it is necessary to maintain a cooling temperature over an entire injection-molded article through optimization of a cooling line.

For example, when injected into a mold through a gate in general injection molding, a raw material has a temperature gradient from a higher temperature near the gate of the mold to a low temperature near a distal end of the mold. However, for the multi-stage injection molding, the raw material must be maintained at a low temperature throughout the mold to prevent shrinkage of the injected raw material at opposite ends of the mold and delamination of a pattern or figure from the raw material near the gate when the pattern or figure is coated on the raw material by pad printing.

For this purpose, the mold may be designed to concentrically cool the raw material near the gate corresponding to an initial molding part while preventing possible weld lines caused by an excessive decrease of temperature.

Secondly, it is necessary to set a cold sludge well at an ideal position.

For injection molding operation, it is necessary to set a proper position of the cold sludge well, which filters sludge of the gate and a nozzle during injection.

For a grip part of the steering wheel according to the embodiment, since the pattern or figure is inserted between the layers by the multi-stage injection molding, it is important to ensure transparency in secondary injection molding. Therefore, there is a need for a mold manufacturing technology that can prevent generation of the weld lines or flow marks caused by improper flow of the raw material or inflow of foreign matter.

Thirdly, it is necessary to set the gate at an ideal position in the mold to prevent delamination of the pattern or figure during multi-stage injection molding.

In other words, according to the invention, after primary or secondary injection molding, the pattern or figure is inserted by pad printing or vacuum deposition, followed by subsequent injection molding thereon.

Here, it was found that the pattern positioned near the gate of the mold was substantially delaminated from the injection-molded part due to structural imperfection in the injection-molded multilayer shape, high injection pressure, and high melting point. Thus, it is necessary to ideally position the gate in the mold to prevent such problems.

Fourthly, it is necessary to set a proper position of a gas vent that is used to adjust the inner pressure of the mold.

In other words, since the mold for the steering wheel according to the embodiment has an elongated injection zone (generally 350˜400 mm or more), there is a flow of the injection-molded article by injection pressure inside the mold during the injection molding, thereby causing thickness deviation across the injection-molded article. Therefore, to prevent such a problem, it is necessary for the gas vent to be properly positioned to reduce the inner pressure of the mold.

Particularly, when a resin such as acrylonitrile butadiene styrene (ABS) or polypropylene (PP) is used, the gas vent generally has a depth of about 0.02-0.05 mm. However, when polycarbonate (PC) is used for the multi-stage injection molding according to the invention, the gas vent may be set to have a depth of about 0.3˜0.5 mm for convenient operation. If the gas vent is formed deeper than this value, the material is likely to undergo scattering when injected.

Fifthly, it is necessary to set a proper length of each injection zone in an injection-molded part to prevent delamination of the pattern or figure from the injection-molded pat near the gate of the mold during the multi-stage injection molding.

Thicknesses of primary and secondary injection zones in a flow direction of the raw material may be set such that one of the primary and secondary injection zones has a thickness 1˜1.5 times that of the other in the injection-molded part passing a ring-gate.

On the other hand, the following conditions may be considered in the multi-stage injection molding to insert the pattern or figure into the steering wheel according to the embodiment of the invention.

Firstly, it is necessary to inject a high-temperature low-fluidity material at low temperature and high pressure.

Injection of the high-temperature low-fluidity material at low temperature and high pressure provides severe weld lines and possibility of flow marks that can occur when a leading flow having a cooled surface layer resulting from low-temperature injection meets another kind of flow.

To prevent the weld lines, increase in temperature of the mold surface, increase in size of a sprue channel, the gate and the nozzle, prevention of abrupt change in wall thickness, and proper installation of a vent duct may be performed.

Secondly, it is necessary to set a proper injection thickness for each layer.

To minimize the surface delamination at the gate of the mold, the mold is designed such that the injection-molded part has a thickness 1˜1.5 times the thickness of a zone between the ring gate and the injection-molded part, that is, the thickness of the lowermost end of a leather insertion part. In this context, it was found that injection molding of a thin sheet having a thickness of 2 mm or less entailed frequent occurrence of surface delamination due to a higher flow rate at the gate, whereas injection molding of a thick sheet having a thickness three times that of the thin sheet, that is, a thickness of 5 mm or more entailed frequent occurrence of imperfections, such as weld lines, shrinkage, pores, and the like, due to a lower flow rate.

Thirdly, it is necessary to prevent movement in a long injection zone, where a support is not provided, in the multi-stage injection molding.

For example, the multi-stage injection molding is performed in the sequence of a first high-rate injection stage, a second medium-rate injection stage, a third low-rate injection stage, and a fourth high-rate injection stage.

As such, four-stage pressure adjustment may be adopted to minimize a deformation zone relating to an insert in such a way that the first high-rate injection stage is performed from an inlet of the nozzle to an inlet of the gate, the second medium-rate injection stage is performed from the inlet of the gate to a start zone of the injection-molded part, the third low-rate injection stage is performed from the start zone of the injection-molded part to a distal end of the deformation zone, and the fourth high-rate injection stage is performed from the distal end of the deformation zone to a distal end of the injection-molded part.

Fourthly, it is necessary to prevent generation of pores in each layer during the multi-stage injection molding.

For this purpose, the raw material may be sufficiently dried and may contain as few surfactants such as wax or the like as possible. Further, injection pressure and pressure-hold time may be increased.

Moreover, a cooling rate may be lowered to prevent abrupt change in thickness of the injection-molded part, residing time of the raw material in a cylinder of the mold may be decreased as much as possible, and the molding temperature of the raw material may be lowered.

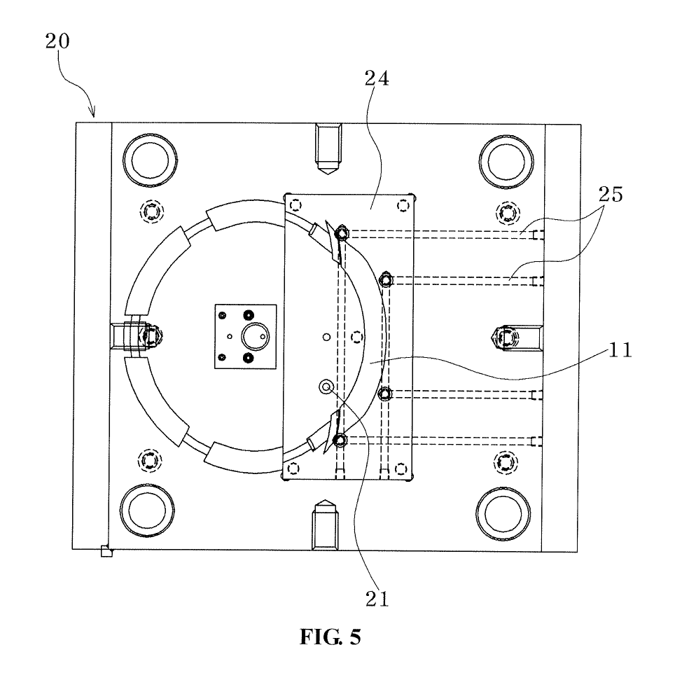

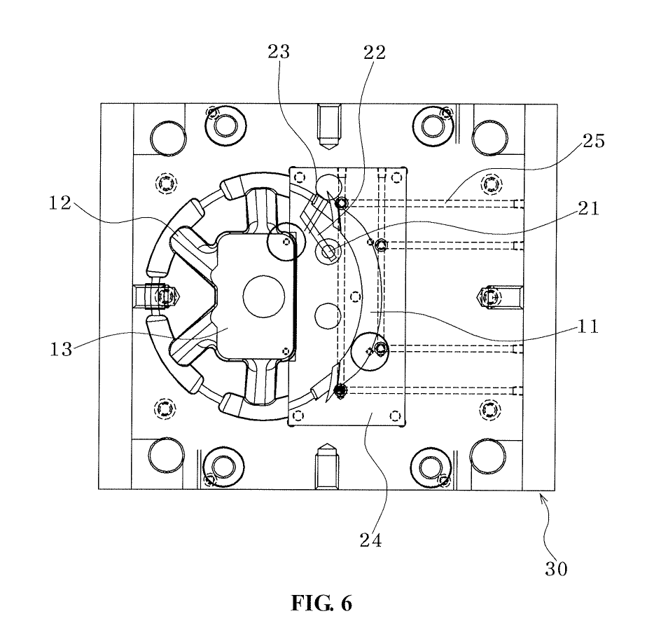

A mold satisfying the requirements for the steering wheel according to the embodiment of the invention as described above is shown in FIGS. 5 to 7.

Since the steering wheel according to the embodiment of the invention is formed in multiple layers having a thickness difference of 2˜3 mm by injection molding, the mold for the steering wheel has the structure as shown in FIGS. 5 to 7.

Herein, it should be noted that injection ports of molds are set to have slightly different sizes in consideration of the injection ports which are subjected to change in thickness according to the number of sequent injection processes in practice.

Hereafter, the mold for the steering wheel according to the embodiment of the invention will be described in detail with reference to FIGS. 5 to 7.

Referring to FIGS. 5 to 7, the mold for the steering wheel according to the embodiment is used to form the upper portion 2, lower portion 3 and lateral portions of the steering wheel 1. The mold allows injection molding for each portion of the steering wheel to be performed corresponding to the shape of the portions, and generally includes an upper mold 20, a lower mold 30, and an ejector 40 which releases the steering wheel 1 from the mold.

The upper mold 20 is provided with a gate 21, a runner 22, and a ring-gate 23, through which a resin for injection molding is supplied into the upper mold 20.

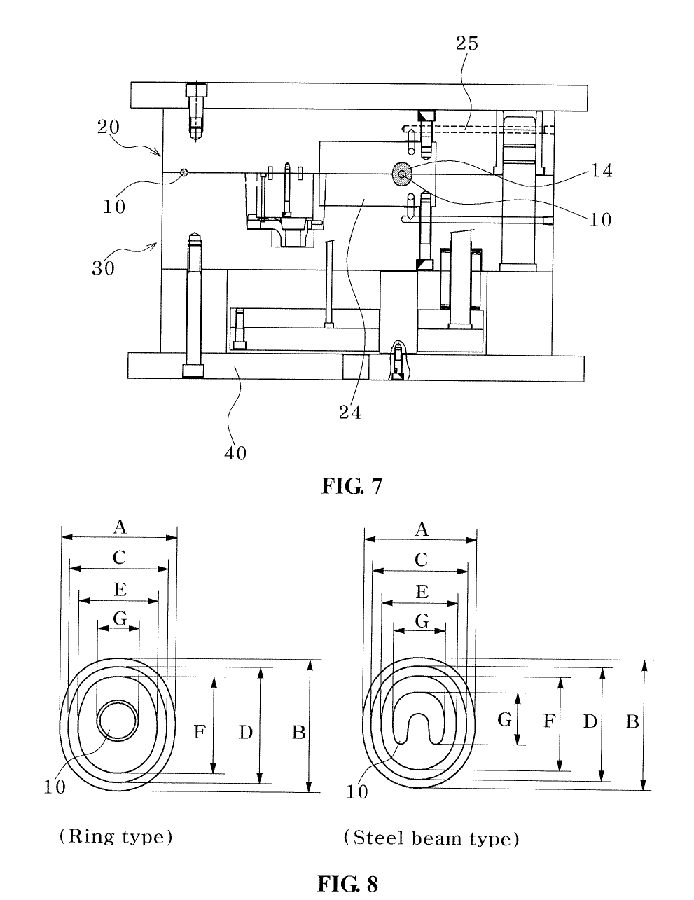

Referring to FIG. 7, the lower mold 30 is assembled to the upper mold 20 and is provided at a lower portion thereof with the ejector 30, which releases an injection-molded article from the lower mold 30 when the injection molding is completed.

Further, the mold includes a cooling line 25 and a block 24 for adjusting the height of the steering wheel 1, which is not provided with a supporter, between the upper and lower molds 20, 30.

The hub core 13, the plurality of spokes 12, and the metal frame 10 corresponding to opposite lateral sides of the rim 11 are disposed in the upper and lower molds 20, 30. The resin will not be fed to these components of the steering wheel in the mold.

It should be noted that the upper and lower molds 20, 30 define a space for forming the rim 11 through injection molding, and an injection-molded part constituting the rim 11 is formed by feeding the resin into the space defined therein.

The upper and lower portions 2, 3 constituting the rim 11 may be formed of the same resin material. According to one embodiment, the resin material comprises polycarbonate (PC) or polyethylene terephthalate (PET).

Polycarbonate (PC) or polyethylene terephthalate (PET) may be processed to be transparent or semi-transparent and allows imperfections such as pores or the like to be easily found during fabrication of the steering wheel. Further, when transparent polycarbonate (PC) or polyethylene terephthalate is used for the upper and lower portions 2, 3, a pattern part may be easily observed therethrough.

The lateral sides of the rim 11 may be formed of polyurethane foam, which contains polyol, isocyanate and a coloring agent and is foamed at room temperature.

Here, when pores are generated during injection molding, they provide an unpleasant appearance and cause brittleness of the upper and lower portions 2, 3 of the rim 1, thereby causing deterioration in strength and stability of the steering wheel 1.

Accordingly, it is desirable that generation of the pores be prevented as much as possible during injection of the resin.

A method of inserting a pattern or figure into the steering wheel according to the embodiment fabricated using the mold described above includes, but is not limited to, pad printing or a combination of pad printing and vacuum deposition.

Herein, the term “pad printing” refers to a series of processes of designing a pattern to be inserted into the steering wheel 1, fabricating an etching plate based on the pattern output as a film, attaching the etching plate to a pad device, applying an ink to the etching plate via an ink applicator, an ink-cup holder and a stationary unit, printing the pattern to a target via a silicon pad, which transfers an ink pattern from the etching plate to the target.

As such, the pad printing is a printing process that transfers an ink pattern from the etching plate to a transfer pad member, which is made of an elastic material such as rubber, silicone rubber, glue and the like, and then transfers the pattern from the transfer pad member to a target.

In this process, the pattern is printed on a small area having a flat region, a rounded region, a concave region, and a convex region by a pad printer. The etching plate is fabricated by etching an iron plate to a depth of about 0.2 mm and may include a graduated printing plate.

Herein, the term “vacuum deposition” refers to a process of forming a thin film on a target by evaporating a metal, a metallic compound or an alloy by heating and condensing vapor of the metal or metallic compound on the target surface. The vacuum deposition also refers to vacuum metalizing.

The vacuum deposition may be applied to any metallic or non-metallic material and may be easily performed using any proper device.

The vacuum deposition may be performed at a pressure of 10⁻⁴˜10⁻⁷ mmHg (Torr). If the vacuum deposition is performed in an insufficient vacuum, the vapor molecules of the metal or metallic compounds repetitiously collide with each other in the course of moving to the surface of the target so that some of the vapor molecules can fail to reach the surface of the target or can collide with oxygen molecules in air to be oxidized, thereby deteriorating thin film quality.

Generally, the vacuum deposition is performed for a very short time, for example, 15˜30 seconds, but exhaustion from a metalizing tank is performed for a significant time.

It should be noted that exhaustion time depends on a target material. For example, if the target material is a plastic material, a large amount of gas is generated from the surface of the target material, thereby making it difficult to obtain a suitable vacuum.

Further, the target material may be maintained in a chemically clean state using a proper agent. If the target material has a rough surface, the target material may be subjected to grinding and painting.

As described above, the steering wheel according to the embodiment is fabricated by multi-stage injection molding and includes a predetermined pattern or figure inserted therein by the pad printing or a combination of the pad printing and the vacuum deposition. Here, it should be understood that the steering wheel according to the embodiment can be realized as various examples.

Next, a method of fabricating a steering wheel according to the invention will be described briefly with reference to some of the examples.

### Example 1

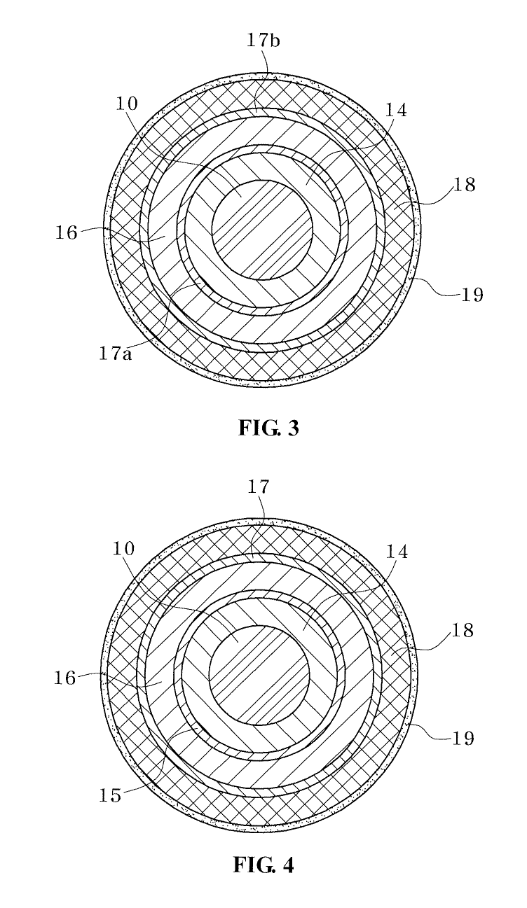

Example 1 relates to a method of fabricating a steering wheel by inserting a plurality of pattern parts through application of pad printing during multi-stage injection molding with the mold as shown in FIG. 3.

The method of Example 1 generally includes preheating, formation of a primary injection-molded part, insertion of a primary pattern part, formation of a secondary injection-molded part, insertion of a secondary pattern part, formation of a tertiary injection-molded part, formation of polyurethane foam, formation of a protective coating, and leather sewing.

The preheating is performed to preheat a hub core 13 integrally connected to a metal frame 10 in a dryer.

For this operation, the hub core 13 integrally connected to the metal frame 10 is prepared.

The hub core 13 and the metal frame 10 are subjected to various examinations to determine whether they are suitable in terms of quality and other conditions for fabrication of a steering wheel.

After the examinations, the hub core 13 integrally connected to the metal frame 10 is preheated in the dryer.

Here, preheating may be performed at 80˜100° C. in the dryer for about 1 hour.

The reason for preheating the hub core 13 and the metal frame 10 is to evaporate moisture from the surfaces of the hub core 13 and the metal frame 10. That is, if moisture is contained on the surface of the metal frame 10 and hub core 13, there are problems, such as delamination of injected materials from the metal frame 10 and the hub core 13, severe surface pores, and the like, during injection molding, thereby causing deterioration in quality and strength of a final article.

Further, a preheating temperature of 80˜100° C. is determined as a drying temperature to evaporate moisture from the surface of the metal frame 10 and hub core 13. If preheating is performed at a temperature less than 80° C., the drying time is extended, and if preheating is performed at a temperature above 100° C., the coating is separated from the metal frame 10 and the hub core 13, if coated, and is stuck to a primary injection-molded part.

Further, a preheating time of 1 hour is determined based on the fact that 1 hour is sufficient to completely evaporate moisture from the surfaces of the metal frame 10 and the hub core 13, and preheating exceeding 1 hour becomes meaningless.

After evaporating moisture from the metal frame 10 and the hub core 13 by preheating in the dryer, the metal frame 10 and the hub core 13 are inserted into a primary injection mold to form the primary injection-molded part 14 (innermost layer).

In other words, the primary injection-molded part formation is performed. After the preheating described above, the hub core 13 integrally connected to the metal frame 10 is inserted into the assembled mold composed of the upper and lower molds 20, 30, as shown in FIGS. 5 to 7.

Then, an opaque resin is injected into the mold through the gate 21 of the upper mold 20 to form (cover) the primary injection-molded part 14 on the metal frame 10.

Here, polycarbonate (PC) is used as the opaque resin.

Further, when the resin is injected into the mold, injection molding is performed based on the aforementioned injection molding technique capable of preventing movement in a long zone where the support is not provided. Therefore, the injection molding is performed in the sequence of the first high-rate injection stage, the second medium-rate injection stage, the third low-rate injection stage, and the fourth high-rate injection stage.

That is, the first high-rate injection stage is performed from an inlet of the nozzle to an inlet of the gate, the second medium-rate injection stage is performed from the inlet of the gate to a start zone of the injection-molded part, the third low-rate injection stage is performed from the start zone of the injection-molded part to a distal end of the deformation zone, and the fourth high-rate injection stage is performed from the distal end of the deformation zone to a distal end of the injection-molded part.

Then, the article having the primary injection-molded part 14 is taken out of the mold and is dried at a temperature of 80˜100° C. in the dryer.

When the surface of the primary injection molded part 14 is exposed to air, it absorbs moisture from the air, thereby deteriorating adhesion and quality during secondary injection molding as a post-process. Therefore, it is necessary to dry the article having the primary injection-molded part during the process.

In this way, drying is performed in each of subsequent processes, as needed, for the same reason. Thus, a repetitious description of drying in the dryer will be omitted.

After the primary injection-molded part formation, the primary pattern part insertion is performed.

In the primary pattern part insertion, a desired pattern or figure is printed on an outer peripheral surface of the primary injection-molded part 14 by pad printing as described above.

In other words, pad printing is performed on an upper side with reference to a border line of the primary injection-molded part 14 to form an upper pattern part.

Then, the article having the upper pattern part is dried at 80˜100° C. in the dryer for 3 hours.

Then, pad printing is additionally performed on a lower side with reference to the border line of the primary injection-molded part 14 to form a lower pattern part, thereby completing the formation of the primary pattern part 17a.

Then, the article having the primary pattern part 17a is dried at 80˜100° C. in the dryer for 3 hours or more.

After the insertion of the primary pattern part, the article is subjected to the secondary injection-molded part formation.

The secondary injection-molded part formation is performed using a secondary mold which has the same structure as that of the mold shown in FIGS. 5 to 7 and is thicker than the primary mold used for forming the primary injection-molded part 14.

In other words, after the primary pattern part insertion, the article is inserted into the secondary mold and a transparent resin is injected into the secondary mold to form the secondary injection-molded part 16 which is 2˜3 mm thicker than the primary injection-molded part 14.

Here, polycarbonate (PC) is used as the transparent resin, and, as in the formation of the primary injection-molded part 14, injection molding is performed in the sequence of the first high-rate injection stage, the second medium-rate injection stage, the third low-rate injection stage, and the fourth high-rate injection stage.

Then, the article having the secondary injection-molded part 16 is taken out of the secondary mold and is dried at a temperature of 80˜100° C. in the dryer, thereby completing the formation of the secondary injection-molded part.

After the secondary injection-molded part formation, the secondary pattern part insertion is performed.

The secondary pattern part insertion is performed by the same procedure as that for the primary pattern part insertion.

In other words, pad printing is performed on an upper side with reference to a border line of the secondary injection-molded part 16 to form an upper pattern part, followed by drying the upper pattern part at 80˜100° C. in the dryer for 3 hours or more. Then, pad printing is additionally performed on a lower side with reference to the border line of the secondary injection-molded part 16 to form a lower pattern part, followed by drying the lower pattern part at 80˜100° C. in the dryer for 3 hours or more, thereby completing the secondary pattern part insertion to form a secondary pattern part 17b.

Here, the primary and secondary pattern parts 17a, 17b may have, but are not limited to, a wood grain pattern or an undulation pattern.

Then, the article having subjected to the secondary pattern part insertion is inserted into a tertiary mold and a transparent resin is injected into the tertiary mold to form a tertiary injection-molded part 18 as the outermost injection-molded part which is 2-3 mm thicker than the secondary injection-molded part 16.

As in the secondary injection-molded part 16, the tertiary injection-molded part 18 is also formed of polycarbonate (PC).

After the tertiary injection-molded part formation, the polyurethane foam formation is performed.

The polyurethane foam formation is a process of withdrawing the article from the tertiary injection mold, and foaming polyurethane on an outer peripheral surface of the tertiary injection-molded part excluding the primary and secondary pattern parts 17a, 17b to have a thickness, from which a thickness of leather constituting a rim 11 of the steering wheel is subtracted, to provide a desired thickness of the rim 11.

After the polyurethane foam formation, the protection coating formation is performed as a finishing process to form a protection cover 19 corresponding to the outermost layer of the steering wheel 1.

The protection coating formation is a process of performing surface grinding to remove the lines of the injection molded parts and coating the injection-molded layer through cleaning operation to protect an outer injection-molded layer from external impact and contamination.

After the protection cover 19 is formed, leather sewing is performed to sew a leather member to the polyurethane foam part.

Then, a final steering wheel 1 is output through a predetermined examination.

As such, the steering wheel 1 of Example 1 is formed with the primary and secondary pattern parts 17a, 17b on the outer peripheral surfaces of the primary and secondary injection-molded parts 14, 16 inside the steering wheel 1, respectively, in which the secondary and tertiary injection-molded parts 16, 18 are composed of the transparent resin to allow the pattern parts 17a, 17b to be seen from the outside therethrough, thereby improving an aesthetic appearance of the steering wheel 1.

### Example 2

Example 2 relates to a method of fabricating a steering wheel 1 by inserting a vacuum deposition part 15 and a pattern part 17 through a combination of vacuum deposition and pad printing during multi-stage injection molding with the mold as shown in FIG. 4.

The method of Example 2 includes preheating, formation of a primary injection-molded part, insertion of a vacuum deposition part, formation of a secondary injection-molded part, insertion of a pattern part, formation of a tertiary injection-molded part, formation of polyurethane foam, formation of a protective coating, and leather sewing.

The preheating is performed to preheat a hub core 13 integrally connected to a metal frame 10 in a dryer, and is the same as in Example 1. Thus, a detailed description thereof will be omitted herein.

Here, an opaque resin for the primary injection-molded part 14 may be polycarbonate (PC). However, in Example 2, polyethylene terephthalate (PET) is used as the opaque resin for the primary injection-molded part 14.

After the primary injection-molded part formation, the vacuum deposition part formation is performed to form the vacuum deposition part 15 on an outer peripheral surface of the primary injection-molded part 14 to provide a metallic appearance.

In other words, the vacuum deposition (or vacuum metalizing) as described above is performed to form the vacuum deposition part 15 on the outer peripheral surface of the primary injection-molded part 14.

Herein, the vacuum deposition is performed to obtain a design, which cannot be realized by a conventional technique. In a conventional pad printing process, a secondary pad pattern is printed using color of a basic pigment, which is the same as that of the primary injection-molded part 14. However, the vacuum deposition provides a metallic appearance, which cannot be realized by the color of the primary injection-molded part 14.

Particularly, in Example 2, a vacuum deposition material for providing the metallic appearance may include, but is not limited to, aluminum (Al) and zinc (Zn), which both have a high thermal expansion coefficient, to prevent surface cracks. If chrome is used as the vacuum deposition material, it cannot absorb thermal expansion of the primary injection-molded part due to rigidity thereof.

Here, the injection molded-part may be processed to have a proper surface roughness. In other words, when the surface of the injection molded-part is excessively smooth, molecular chain structure is liable to be broken and cause delamination of the surface of the injection molded-part. In contrast, when the surface of the injection molded-part is too rough, there is likelihood of paint separation from the surface of the injection molded-part.

After the vacuum deposition part formation, the secondary injection-molded part formation is performed to form the secondary injection-molded part 16.

The secondary injection-molded part formation is performed using a secondary mold which has the same structure as that of the mold shown in FIGS. 5 to 7 and is 2˜3 mm thicker than the primary mold used for forming the primary injection-molded part 14. The secondary injection-molded part formation of Example 2 is the same as that of Example 1, and thus a detailed description thereof will be omitted herein.

Here, a transparent resin for the secondary injection-molded part 16 may be polycarbonate (PC) as in Example 1. However, in Example 2, polyethylene terephthalate (PET) is used as the transparent resin for the secondary injection-molded part 16.

After the formation of the secondary injection-molded part, the secondary pattern part insertion is performed by pad printing.

The pattern part insertion is performed by the same procedure as that for the insertion of the primary and secondary pattern parts described above in Example 1.

In other words, pad printing is performed on an upper side with reference to a border line of the secondary injection-molded part 16 to form an upper pattern part, followed by drying the upper pattern part at 80˜100° C. in the dryer for 3 hours or more. Then, pad printing is additionally performed on a lower side with reference to the border line of the secondary injection-molded part 16 to form a lower pattern part, followed by drying the lower pattern part at 80˜100° C. in the dryer for 3 hours or more, thereby completing the pattern part insertion to form a pattern part 17.

Here, the pattern part 17 may have, but is not limited to, a wood grain pattern or a rippled pattern.

Then, the article having been subjected to the pattern part insertion is inserted into a tertiary mold and a transparent resin is injected into the tertiary mold to form a tertiary injection-molded part 18 as the outermost injection-molded part which is 2˜3 mm thicker than the secondary injection-molded part 16.

In addition to the tertiary injection-molded part formation, the polyurethane foam formation, protective coating formation, and leather sewing of Example 2 are the same as those of Example 1, and a detailed description thereof will be omitted herein.

As such, the steering wheel 1 of Example 2 is formed with the vacuum deposition part 15 providing the metallic appearance and the secondary pattern part 17 on the outer peripheral surfaces of the primary and secondary injection-molded parts 14, 16 inside the steering wheel 1, respectively, in which the secondary and tertiary injection-molded parts 16, 18 are formed of the transparent resin to allow the vacuum deposition part 15 and the secondary pattern part 17 to be seen from the outside therethrough, thereby improving an aesthetic appearance of the steering wheel 1.

On the other hand, FIG. 8 shows variation in thickness of respective injection-molded parts according to the shape of a metal frame of a steering wheel formed by three-stage injection molding according to one embodiment of the present invention.

In other words, it was found based on investigations of the inventors that, when the outermost injection-molded layer had a thickness of 2˜3 mm with a pattern inserted under the outermost layer, the pattern appeared more pleasant and luxurious and provided a voluminous appearance. Particularly, the thickness of each part determined in consideration of strength according to a ring type and a steel beam type can be identified from FIG. 8 and Table 1

TABLE 1
(unit: mm)

| | Pipe shape | A | B | C | D | E | F | G |
|---|---|---|---|---|---|---|---|---|
| 1 | Ring type | 27 | 33 | 23 | 29 | 19 | 25 | 12.7 |
| 2 | Steel beam | 27 | 33 | 23 | 29 | 19 | 25 | 15 |
| | type | | | | | | | |

As shown in Table 1, in each of the examples, the injection molded-part is formed in multiple layers having a thickness difference of 2˜3 mm by multi-stage injection molding and a predetermined pattern or figure is inserted between the layers, thereby providing a pleasant and luxurious appearance to the steering wheel.

As apparent from the above description, according to one embodiment of the invention, the method provides a steering wheel that is formed in multiple layers having a thickness difference of 2˜3 mm by multi-stage injection molding and has a predetermined pattern or picture inserted between the layers, so that the steering wheel has a luxurious and pleasant appearance. As such, the method can replace the conventional wood-grain hydraulic transfer process.

Particularly, when the outermost layer is maintained in an injection-molded thickness of 2˜3 mm with a pattern inserted under the outermost layer, the pattern appears more pleasant and luxurious and provides a voluminous appearance.

Further, the method according to the embodiments of the invention permits production of a steering wheel with a small number of operators, thereby enabling reduction of startup costs to one-fifth that of the conventional technique while overcoming the problems of the conventional film transfer process, which requires a robot or a time-consuming operation due to operational difficulty and complication of the conventional process.

Although some embodiments have been provided to illustrate the invention in conjunction with the drawings, it will be apparent to those skilled in the art that the embodiments are given by way of illustration only, and that various modifications, changes, additions, and substitutions can be made without departing from the spirit and scope of the invention. The scope of the present invention should be limited only by the accompanying claims and equivalents thereof.

What is claimed is:

1. A method of fabricating a steering wheel by injecting a resin material onto a circular metal frame, comprising:
preheating the metal frame at 80˜100° C. in a dryer for 1 hour;
forming a primary injection-molded part by inserting the metal frame into a primary injection mold, injecting an opaque resin into the primary injection mold to form the primary injection-molded part on the metal frame, and drying the metal frame having the primary injection-molded part at 80˜100° C. in the dryer;
inserting a primary pattern part by performing pad printing on an upper side with reference to a border line of the primary injection-molded part to form an upper pattern, drying the metal frame having the upper pattern at 80˜100° C. in the dryer for 3 hours or more, performing pad printing on a lower side with reference to the border line of the primary injection-molded part to form a lower pattern, and drying the metal frame having the lower pattern at 80˜100° C. in the dryer for 3 hours or more;
forming a secondary injection-molded part by inserting the metal frame having the primary pattern part into a secondary injection mold, injecting a transparent resin into the secondary injection mold to form the secondary injection-molded part having a thickness 2˜3 mm greater than the primary injection-molded part, and drying the metal frame having the secondary injection-molded part at 80˜100° C. in the dryer;
inserting a secondary pattern part by performing pad printing on an upper side with reference to a border line of the secondary injection-molded part to form an upper pattern, drying the metal frame having the upper pattern at 80˜100° C. in the dryer for 3 hours or more, performing pad printing on a lower side with reference to the border line of the secondary injection-molded part to form a lower pattern, and drying the metal frame having the lower pattern at 80˜100° C. in the dryer for 3 hours or more;
forming a tertiary injection-molded part as an outermost layer by inserting the metal frame having the secondary pattern part into a tertiary injection mold and injecting a transparent resin into the tertiary injection mold to form the tertiary injection-molded part having a thickness 2˜3 mm greater than the secondary injection-molded part; and
withdrawing the metal frame having the tertiary injection-molded part from the tertiary injection mold, and foaming polyurethane on an outer peripheral surface of the tertiary injection-molded part excluding the pattern parts to have a thickness, from which a thickness of leather constituting a rim of the steering wheel is subtracted, to provide a desired thickness of the rim.

2. A method of fabricating a steering wheel by injecting a resin material onto a circular metal frame, comprising:
preheating the metal frame at 80˜100° C. in a dryer for 1 hour;
forming a primary injection-molded part by inserting the metal frame into a primary injection mold, injecting an opaque resin into the primary injection mold to form the primary injection-molded part on the metal frame, and drying the metal frame having the primary injection-molded part at 80˜100° C. in the dryer;
forming a vacuum deposition part by performing vacuum deposition on an outer peripheral surface of the primary injection-molded part to provide a metallic appearance and drying the metal frame having the vacuum deposition part at 80˜100° C. in the dryer for 3 hours or more;
forming a secondary injection-molded part by inserting the metal frame having the vacuum deposition part into a secondary injection mold, injecting a transparent resin into the secondary injection mold to form the secondary injection-molded part having a thickness 2˜3 mm greater than the primary injection-molded part, and drying the metal frame having the secondary injection-molded part at 80˜100° C. in the dryer;
inserting a pattern part by performing pad printing on an upper side with reference to a border line of the secondary injection-molded part to form an upper pattern, drying the metal frame having the upper pattern at 80˜100° C. in the dryer for 3 hours or more, performing pad printing on a lower side with reference to the border line of the secondary injection-molded part to form a lower pattern, and drying the metal frame having the lower pattern at 80˜100° C. in the dryer for 3 hours or more;
forming a tertiary injection-molded part as an outermost layer by inserting the metal frame having the pattern part into a tertiary injection mold and injecting a transparent resin into the tertiary injection mold to form the tertiary injection-molded part having a thickness 2˜3 mm greater than the secondary injection-molded part; and
withdrawing the metal frame having the tertiary injection-molded part from the tertiary injection mold, and foaming polyurethane on an outer peripheral surface of the tertiary injection-molded part excluding the pattern part to have a thickness, from which a thickness of leather constituting a rim of the steering wheel is subtracted, to provide a desired thickness of the rim.

3. The method according to claim 1, wherein the opaque resin is one of polycarbonate and polyethylene terephthalate.

4. The method according to claim 1, wherein the transparent resin forming the secondary and tertiary injection-molded parts is one of polycarbonate and polyethylene terephthalate.

5. The method according to claim 2, wherein a material for the vacuum deposition part comprises a metallic material selected from aluminum and zinc to provide a metallic appearance.

6. The method according to claim 2, wherein the opaque resin is one of polycarbonate and polyethylene terephthalate.

7. The method according to claim 2, wherein the transparent resin forming the secondary and tertiary injection-molded parts is one of polycarbonate and polyethylene terephthalate.

8. A steering wheel for automobiles fabricated by the method of claim 1.

9. A steering wheel for automobiles fabricated by the method of claim 2.

10. A steering wheel for automobiles fabricated by the method of claim 3.

11. A steering wheel for automobiles fabricated by the method of claim 4.

12. A steering wheel for automobiles fabricated by the method of claim 5.

13. A steering wheel for automobiles fabricated by the method of claim 6.

14. A steering wheel for automobiles fabricated by the method of claim 7.
